(19) United States
(12) Patent Application Publication
(10) Pub. No.: US 2026/0370649 A1
(43) Pub. Date: Nov. 19, 2026

(54) Adaptive Access for Users of a Cloud-Based System

(71) Applicant: Zscaler, Inc., San Jose, CA (US)

(72) Inventor: Abhishekhar Prasad, San Jose, CA (US)

(73) Assignee: Zscaler, Inc., San Jose, CA (US)

(21) Appl. No.: 19/212,244

(22) Filed: May 19, 2025

(51) Int. Cl. H04L 9/40

(52) U.S. Cl. CPC H04L 63/102; H04L 63/105; H04L 63/20

(57) ABSTRACT

Systems and methods for providing adaptive access for users of a cloud-based system include receiving contextual data related to any of a user or a device, the contextual data including dynamic signals originating from streaming event data and static metadata associated with the user or device; evaluating the contextual data against one or more logical expressions, wherein each logical expression comprises a set of criteria linked by operators, the evaluation determining whether the contextual data satisfies the criteria; and performing one or more adaptive access control actions based on the evaluation, the actions including granting or denying access, issuing a step-up authentication request, isolating activity, or modifying policy enforcement parameters.

### FIELD OF THE DISCLOSURE

The present disclosure generally relates to network and cloud security. More particularly, the present disclosure relates to systems and methods for adaptive access for users of a cloud-based system.

### BACKGROUND OF THE DISCLOSURE

As cloud-based systems become increasingly integral to enterprise operations, ensuring secure and adaptive access control for users, devices, and workloads is a growing challenge. Existing access control mechanisms often rely on static policies or simplistic rule-based frameworks, which struggle to address dynamic and evolving risks in real time. Factors such as fluctuating risk scores, device posture changes, anomalous session activities, and identity modifications necessitate a more flexible and context-aware approach to determining access privileges. Additionally, traditional systems lack the ability to evaluate complex relationships between real-time signals and static metadata, limiting their ability to create nuanced policy definitions and enforce them with precision.

### BRIEF SUMMARY OF THE DISCLOSURE

The present disclosure relates to systems and methods for adaptive access for users of a cloud-based system. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include receiving contextual data related to any of a user or a device, the contextual data including dynamic signals originating from streaming event data and static metadata associated with the user or device; evaluating the contextual data against one or more logical expressions, wherein each logical expression comprises a set of criteria linked by operators, the evaluation determining whether the contextual data satisfies the criteria; and performing one or more adaptive access control actions based on the evaluation, the actions including granting or denying access, issuing a step-up authentication request, isolating activity, or modifying policy enforcement parameters.

The steps can further include wherein the contextual data includes a first attribute related to the user's risk score and a second attribute related to the device posture of a device associated with the user. Receiving contextual data can include aggregating data from multiple sources, including cloud-native services and third-party integrations, and enriching the contextual data using cached metadata from prior evaluations. Evaluating the contextual data can include dynamically reevaluating logical expressions at runtime in response to an update to one or more criteria, wherein the updated criteria are propagated without interruption to ongoing policy enforcement. Performing adaptive access control actions can include overriding the behavior of contextual data for a specified duration of time to temporarily adjust policy enforcement parameters. Overriding contextual data can include assigning an adjusted risk score to the user or device, wherein the adjusted risk score is restored to its original or actual value upon expiration of the specified duration. Performing adaptive access control actions can include issuing isolation instructions for a specific device associated with the user while maintaining access for other devices under the user's account. Static metadata can include user group membership, organizational role, device ownership status, or workload classification stored in a relational database, and the metadata is retrieved and combined with dynamic signals during evaluation. Performing adaptive access control actions can include applying real-time updates to access policy enforcement actions based on modifications to criteria thresholds or rules defined by an administrator. Adaptive access control actions can include notifying administrative systems and generating alerts upon the detection of anomalous contextual signals that exceed predefined risk thresholds.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a flow diagram of an example architecture of the Adaptive Access Engine (AAE).

FIG. 5 is a screenshot of an interactive User Interface (UI) for constructing logical expressions.

FIG. 6 is a flowchart of a process for providing adaptive access for users of a cloud-based system.

FIG. 7 is a flowchart of a process for generating adaptive access policy definitions via logical expressions for use in adaptive access control of a cloud-based system.

Again, the present disclosure relates to systems and methods for adaptive access for users of a cloud-based system. The disclosed invention introduces a cloud-based adaptive access control system that dynamically evaluates contextual data through configurable logical expressions. The system enables administrators to define multi-level nested logical rules incorporating dynamic signals (e.g., risk scores, session activity, device posture) and static attributes (e.g., user group membership, organizational role) for real-time evaluations. Furthermore, the system supports the dynamic modification of logical criteria and context signals, allowing policy enforcement to adapt seamlessly to shifting environmental conditions and organizational priorities. By providing the ability to override signal values temporarily or permanently, the invention offers unparalleled flexibility for managing access control in scenarios requiring immediate adjustments or long-term modifications. This approach ensures that access control remains robust, responsive, and aligned with the dynamic nature of modern cloud environments.

### §1.0 Cybersecurity monitoring and protection examples

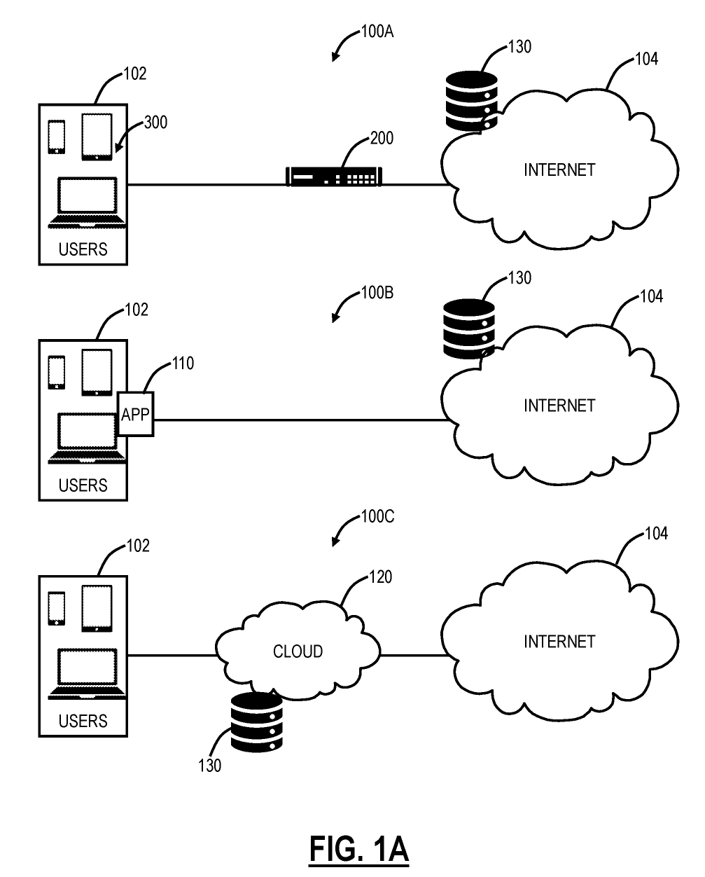

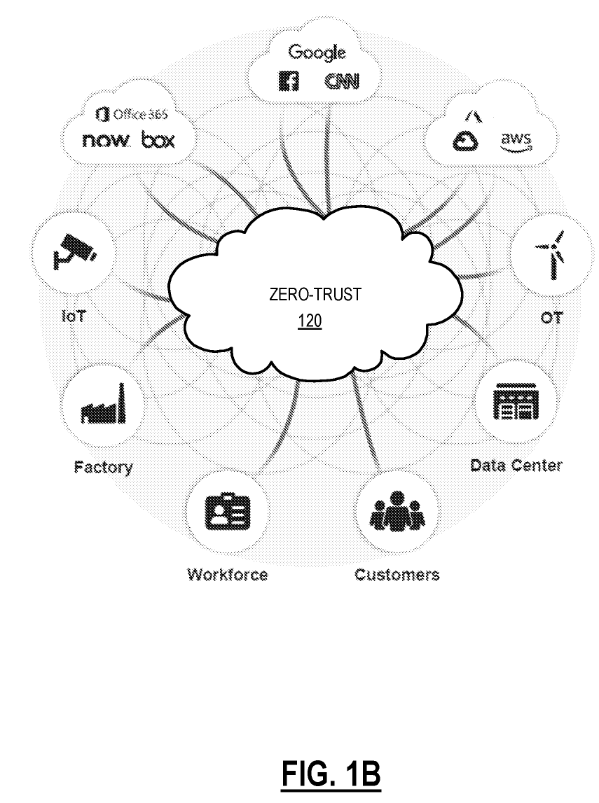

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

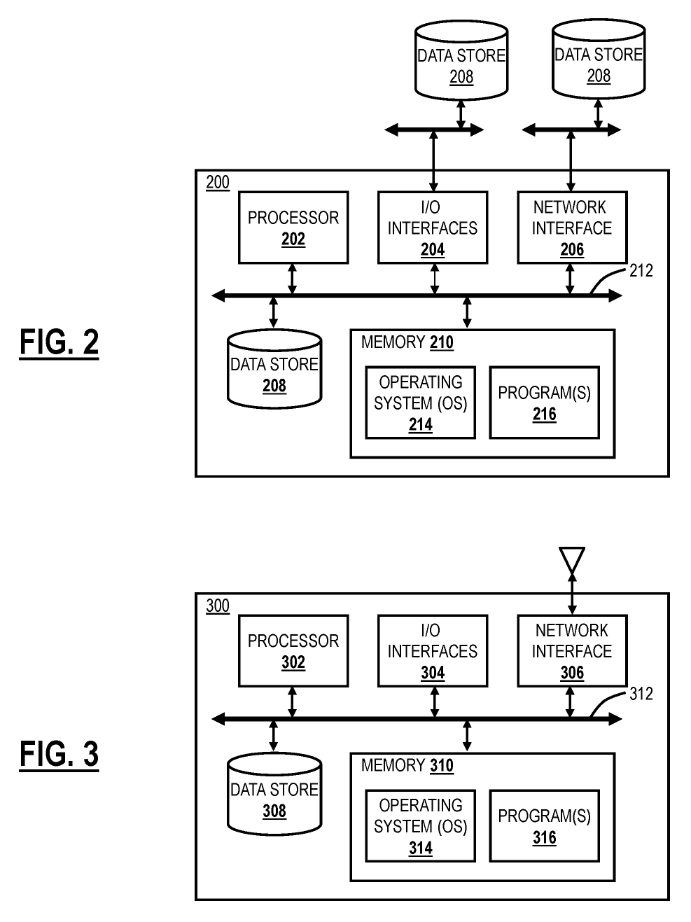

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer’s data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### §1.1 Cloud monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### §1.2 Zero trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### §1.3 Log data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:

Commonly-assigned U.S. Patent No. 8,429,111, issued Apr.23, 2013, and entitled “Encoding and compression of statistical data,” the contents of which are incorporated herein by reference, describes compression techniques for storing such logs,

Commonly-assigned U.S. Patent No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and

Commonly-assigned U.S. Patent Application No. 16/851,161, filed Apr.17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user’s 102 activity. That is, the log data 130 is not merely confined to specific activity (e.g., a user’s 102 social networking activity on a specific site, a user’s 102 search requests on a specific search engine, etc.).

### §2.0 Example server architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### §3.0 Example computing device architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### §4.0 Continuous adaptive access

Modern cloud-based security solutions, such as ZIA (Zscaler Internet Access), ZPA (Zscaler Private Access), and ZCC (Client Connector), are critical components of enterprise security architectures. These systems enable users to securely access resources while enforcing policies based on identity, device posture, and risk signals. However, existing implementations exhibit several inefficiencies and limitations that hinder scalability, adaptability, and seamless integration, especially as signal types and policy complexity grow over time. The following specific problems illustrate the need for a more centralized and scalable approach to adaptive access control.

One-off signal sharing between systems: Currently, the sharing of context signals between cloud systems, such as ZIA, ZPA, and external integrations, relies on bespoke, one-off implementations for transmitting and leveraging risk profiles or contextual data. Examples of these limited approaches include:

Sharing a ZIA user risk profile (both on a daily basis and in real time) directly with ZPA for access decisions.

Identity Threat Detection and Response (ITDR) transmitting risk signals directly to external systems such as Okta for authentication or access control purposes.

ITDR modifying ZPA access policies based on a user’s risk profile without centralized orchestration.

ZIA User and Entity Behavior Analytics (UEBA) moving users between ZIA groups based on behavioral signals and risk evaluation.

ZCC assessing device posture signals and sharing them directly with ZPA for access policy updates.

These ad hoc approaches to signal sharing lack standardization and scalability and inhibit flexibility as the number of contextual signals continues to grow. They generate administrative overhead for security teams who must manage disparate configurations across multiple systems and integrations.

It is noted that the systems/security services including ZIA, ZPA, and ZCC are referenced herein as examples, and it shall be appreciated that any cloud-based service/system can be contemplated.

The existing policy framework used by such services presents substantial challenges in managing adaptive access at scale. For instance, a service can include a plurality of different policy types, each containing potentially long lists of rules with associated criteria. Some customers/tenants report managing over 2,000 individual rules across policies, creating substantial inefficiency.

One major limitation with the current framework is that not all contextual signals are universally accessible across policy types. When new types of context signals are added, administrators must manually add them to each applicable policy type or individual rules, a time-consuming and error-prone process. Furthermore, criteria cannot be reused across policies or even within rules belonging to the same policy. If a new criterion needs to be evaluated across multiple access rules, administrators must redundantly configure it in numerous locations, compounding effort and risk of misconfiguration.

This fragmented approach creates unnecessary administrative burden, limits reusability, and reduces efficiency, particularly as the number of signals and policies expands. Without centralized management, adaptive access sprawls into unwieldy configurations that limit flexibility and inhibit scalability for enterprises.

Collectively, these challenges, ranging from one-off signal sharing and adaptive access sprawl to the lack of standardized third-party integration models, emphasize the need for a centralized, scalable system capable of managing context signals across disparate systems, integrations, and policy frameworks. The proposed Adaptive Access Engine (AAE) seeks to address these limitations and deliver a unified, versatile platform to enable streamlined administration, dynamic policy reuse, and efficient system integration, all while accommodating the continuous evolution of cloud-based security requirements.

### §4.1 Adaptive access engine

The Continuous Adaptive Access (CAA) framework is a system designed to provide customers of a cloud-based system 120 with a comprehensive solution for monitoring subject activity and enforcing access control policies. CAA enables dynamic, context-aware access decisions by leveraging policy enforcement points integrated into the cloud system’s various security solutions. A core element of CAA involves tracking and distributing context signals to policy decision points that evaluate access policies based on the changing nature of identities, resources being accessed, and the context signals associated with the subjects attempting access. This invention discloses a system referred to as the Adaptive Access Engine (AAE), which acts as a centralized system to share context signals across both cloud-native and third-party services. Although the AAE is a critical component of the CAA framework, it is not a complete solution on its own but instead functions as the foundational element that enables scalable and adaptive access control across diverse systems.

Policies supported by CAA encompass both existing actions, such as allowing or blocking access, and new actions designed to address emerging security needs, including step-up authentication. Step-up authentication introduces an additional tier of security, requiring subjects to provide supplementary verification if their current authentication level is insufficient based on contextual risk signals or the sensitivity of the resource being accessed. For instance, during an access attempt, if the subject’s behavioral or environmental signals indicate heightened risk, the system can dynamically enforce step-up authentication, prompting the subject to prove their identity through additional mechanisms, such as multi-factor authentication. The AAE also facilitates continuous context evaluation throughout an active session. As subject context changes over time, due to factors such as device activity, geographic shifts, or behavioral patterns, policies can adapt in real time, ensuring an always-dynamic, proactive security posture.

Today’s cloud systems often rely on ad hoc methods for signal-sharing and policy execution, resulting in static and narrowly tailored security configurations. Signal-sharing pipelines are typically isolated to individual policy modules, and new signal types often require custom implementation that increases administrative and maintenance overhead for customers. While functional in early implementations, this fragmented approach becomes unsustainable as the volume of signals and the complexity of policies grow. The AAE resolves these challenges by offering a scalable and centralized system for managing and distributing context signals across the cloud ecosystem.

Through centralized processing, real-time signal distribution, and seamless integration with third-party services, the AAE enables administrators and customers to implement scalable security policies across complex environments. The AAE is designed to track and process a growing set of signals without introducing unnecessary bottlenecks, while allowing customers to manage increasingly enriched signals and nuanced policies with ease. By acting as the intermediary for signal-sharing between decision points and enforcement points, the AAE fosters scalable security implementations and positions the cloud system to grow alongside evolving access control challenges. By integrating this innovative solution, the system ensures adaptive, dynamic access control policies can be applied consistently across distributed security environments while enabling the continued enrichment of signal types over time.

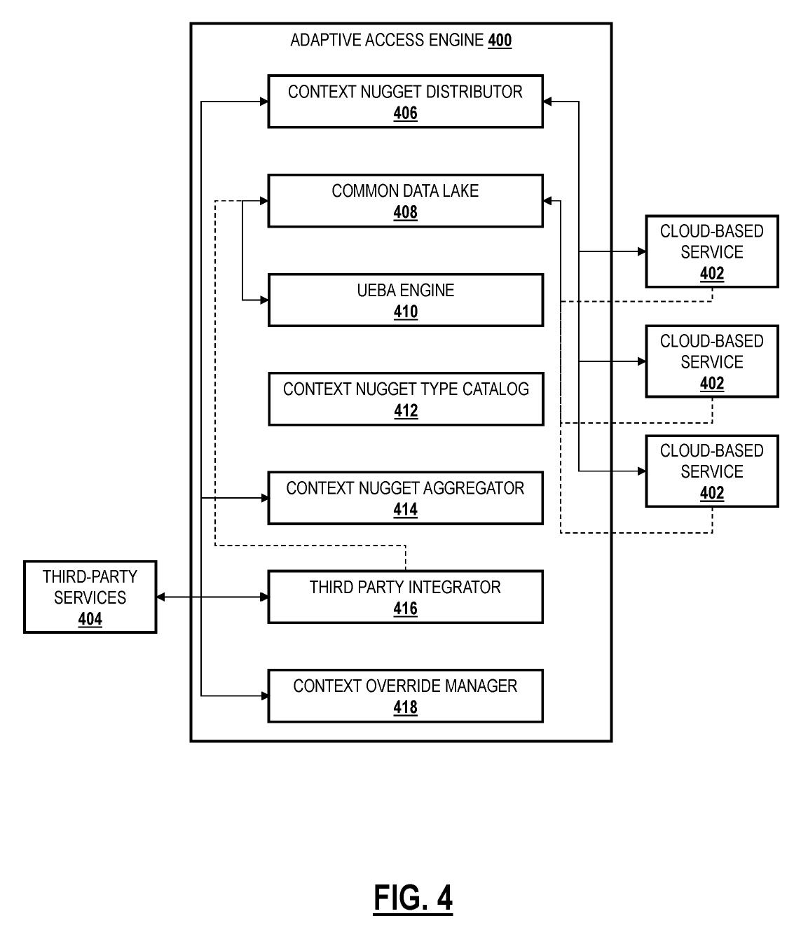

FIG. 4 is a flow diagram of an example architecture of the AAE. The AAE 400 is a centralized system that streamlines the generation, distribution, aggregation, and consumption of context signals across cloud-based services 402 and third-party integrations 404. Log data, which represents raw observations of subject activity (e.g., users, devices, sessions, and locations) and metadata such as source IPs, authentication success or failure events, and resource access attempts are ingested by the AAE 400. Log data (contextual signals, streaming data, etc.) serves as the foundational input for computing context nuggets, which are small, structured data objects associating subjects with calculated risk values. These nuggets encapsulate risk signals derived from one or more pieces of log data, reflecting indicators such as multiple authentication failures, risky device posture, impossible travel patterns, or high-volume document downloads.

The generation and collection of log data are managed by context nugget producers (or log producers), which encompass cloud-based services responsible for detecting contextual signals and publishing data into the common data lake 408. Log producers may also perform computations directly on log data, generating context nuggets that are published into the common data lake for broader system utilization. The common data lake 408 itself acts as a centralized repository, aggregating user, device, and session-related data from all log producers. This repository enables advanced cross-correlation and analysis of activities, allowing the AAE’s components to evaluate historical trends, detect anomalous behaviors, and continuously enrich risk signals. Additionally, smaller, localized repositories called log data ponds, independently maintained by individual log producers, may indirectly contribute to the common data lake 408, providing additional flexibility within the overall framework.

To process and analyze the data stored in the common data lake 408, the AAE 400 employs the User and Entity Behavior Analytics (UEBA) engine 410. This component examines individual log data entries, sequences of data, historical information, and cross-correlated signals from multiple log producers to compute context nuggets. UEBA Engines 410 enable advanced risk evaluation by leveraging behavioral analytics across subjects, producing actionable insights needed to inform access policy decisions. Multiple UEBA Engines 410 may operate within the AAE 400 to process data concurrently, allowing for distributed workloads and scalable risk computation.

The distribution of context nuggets is handled by the context nugget distributor 406, which serves as the central hub for sharing nuggets across the AAE 400 and its integrations. The context nugget distributor 406 receives context nuggets from the UEBA engine 410, the third party Integrator 416, and the context override manager 418, and exposes APIs to be queried by downstream components. Policy enforcement systems such as context nugget consumers, which include cloud-based services 402 like ZPA (Zscaler Private Access), ZIA (Zscaler Internet Access), and ZIdentity, utilize the context nugget distributor 406 to retrieve signals during access and authentication evaluations. Based on the retrieved nuggets, these systems apply policy criteria, taking actions such as permitting access, issuing step-up authentication, blocking access, isolating high-risk sessions, generating alerts, or monitoring user activity.

To integrate third-party risk signals into the AAE 400, the third party integrator 416 provides a standardized interface between external systems, such as customer environments, and the engine itself. This integrator functions as a single integration point to receive context signals or risk evaluations from third parties before publishing them to the common data lake 408 and context nugget distributor 406. Furthermore, it addresses gaps in existing models, such as the reliance on clients to detect device postures, by creating a centralized third party integration cloud where mappings between device IDs and third-party identifiers (UIDs) can occur without involving endpoints directly. While protocols such as System for Cross-domain Identity Management (SCIM) or Security Assertion Markup Language (SAML) may be employed for user attribute provisioning and authentication workflows, they are less suited to real-time sharing of dynamic risk signals. The third party integrator 416 also anticipates broader adoption of emerging standards like the OpenID Foundation’s Shared Signals Framework (SSF), which allows identity providers to share contextual risk events.

Another key component of the AAE 400 is the context override manager 418, which provides a user interface for customers to manually override false positives detected within context nuggets. Customers can use this interface to review and adjust risk evaluations that might otherwise impact access or authentication policies. Overrides are written back into the context nugget distributor 406, refining future analyses and mitigating inaccuracies in downstream risk assessments. Similarly, the context nugget aggregator 414 offers a centralized User Interface (UI) for combining multiple context nuggets and their associated thresholds into simplified conditions for use in policy rules. For example, customers could create rules combining signals such as excessive failed login attempts, impossible travel events, high document download volume, and risky device posture into a unified risk evaluation. This aggregation capability reduces complexity for policy enforcement systems while enabling nuanced, real-world adaptations of risk signals.

Finally, the AAE 400 incorporates a context nugget type catalog 412, which acts as a registry for all available context nugget types. This catalog allows policy enforcement points, such as context nugget consumers, to dynamically adopt new signals into their criteria. By querying the catalog, these enforcement points can generate policy configurations and UI elements that reflect the inclusion of new nugget types as they are introduced. Additionally, the catalog provides APIs to obtain metadata about individual nuggets, including their provenance and the log data or algorithms employed by the UEBA engine 410 during computation.

The AAE 400 is a sophisticated, modular system designed to orchestrate dynamic context-driven access control policies by aggregating, processing, and distributing contextual signals in real-time. In addition to the previously described components, several additional services and subsystems work in unison to enhance the engine’s scalability, data management, and real-time capabilities. These components further streamline workflows, enable seamless third-party integrations, optimize query capabilities, and ensure efficient synchronization of context-related data across critical services.

One core component of the present system is a context streaming service, which handles several essential processing and distribution tasks within the AAE 400. It consumes context nuggets in Open Security Context Framework (OSCF) format and applies common policy criteria (rules) and administrator-defined overrides to refine nuggets based on specific conditions. Overrides, as defined through the context override manager, allow adjustments to mitigate false positives or refine assessments for accuracy. The context streaming service also stores context nuggets in an elastic search cluster to enable fast, scalable access to contextual data, supports API updates to dynamically refresh common criteria in the engine’s memory, and serves as the primary mechanism for publishing processed context nuggets to downstream systems (e.g., context nugget consumers). By consolidating these processing workflows into a single service, the context streaming service ensures efficient, centralized handling of contextual data throughout the AAE 400.

Managing the authoritative catalog of all producers, consumers, and context types within the system is the role of the context engine catalog manager. This component provides registration and un-registration capabilities for both context nugget producers and context nugget consumers, ensuring that the AAE 400 has full visibility into which components are contributing or utilizing context nuggets. It also offers APIs for querying metadata about context types, producers, or even consumer-specific configurations, enabling administrators and integrated systems to programmatically interact with catalog information. These APIs provide a vital backbone for maintaining accurate data about all entities participating within the AAE 400.

Complementing this capability is the context engine manager, which provides comprehensive crud (create, read, update, delete) functionalities via a set of APIs. This service is primarily used for creating and modifying common criteria (rules) and nugget overrides, giving administrators granular control over how context nuggets are processed and distributed. By offering a centralized interface for managing criteria and overrides, the context engine manager enhances policy flexibility, making it straightforward for enterprises to adjust policy logic based on evolving security needs or organizational requirements.

A crucial part of the system’s message distribution infrastructure is implemented via Kafka topics, which facilitate asynchronous, high-throughput communication between components. Kafka handles multiple streams of context-related data, including a topic for consuming incoming context nuggets while performing schema validation, a topic for publishing validated nuggets to downstream systems, and a topic for tracking changes in common criteria. These message streams provide a reliable, scalable architecture for real-time data processing and ensure that changes to common criteria or nugget definitions propagate seamlessly across the AAE’s components.

To enable integration with third-party systems, the third-party connectors transform external context data into the standardized OSCF format accepted by the adaptive access engine. By leveraging attribute mapping, third-party payloads are converted and ingested into the engine without requiring external systems to conform to internal standards. This transformation role simplifies integration, reduces friction for third-party systems, and ensures that all incoming data adheres to the shared schema needed for downstream processing.

For administrators and systems needing historical or query-based context data, the context search service provides a rest API designed to surface historical context information. It supports advanced query patterns to retrieve data about a user, device, or session, enabling detailed evaluations of historical behaviors, log data, and contextual trends. This service empowers enterprise security teams with greater insight into activity patterns, which are vital for auditing decisions, refining policy configurations, or investigating potential incidents.

To maintain data consistency across components, a context data sync service ensures seamless synchronization of user and device metadata across the adaptive access engine. This service ingests metadata related to users and devices, stores it in a Relational Database Service RDS database, and uses Kafka topics to notify other components about changes. Updates initiated by the context data sync service are consumed by the context cache sync service, which is responsible for syncing metadata changes to a Redis cache. The Redis cache ensures low-latency access to frequently used user and device metadata and is made available to key components such as the context streaming service and third-party connectors. This cache centralization minimizes redundant calls to databases and optimizes performance for components that rely on quick access to context-rich metadata.

Together, these additional components extend the capabilities of the AAE 400, ensuring the smooth ingestion, processing, and distribution of contextual signals. The context streaming service, context engine catalog manager, and context engine manager simplify core workflows such as nugget processing, policy management, and system registrations. The Kafka topics and third-party connectors ensure a robust, scalable message and integration architecture, while the context search service, context data sync, and context cache sync collectively manage synchronization and retrieval of historical and real-time metadata. The interplay between these components allows enterprises to achieve fine-grained control over their adaptive access policies while maintaining the scale required to process thousands of signals, rules, and integrations in real time.

Through this interconnected architecture, the AAE 400 delivers a scalable, centralized solution for managing contextual signals, enabling enterprises to implement adaptive access controls based on dynamic risk evaluations. Its modular design not only streamlines administrative tasks, such as policy configuration and signal management, but also creates a unified framework for integrating third-party systems and continuously enriching context signals. By empowering seamless signal sharing, efficient policy evaluation, and scalable integrations, the adaptive access engine addresses the limitations of fragmented security implementations and lays the foundation for dynamic, robust cloud-based access control.

The AAE 400 implements a seamless, event-driven data flow architecture that enables real-time ingestion, enrichment, and distribution of contextual signals across its components. At the starting point of the data flow, producers and third-party connectors send contextual events to the context engine streaming service. These producers, which include cloud-based services 402 as well as external third-party services/integrations 404, originate events containing raw metadata about user activity, device posture, session details, or other context signals. Third-party connectors transform external payloads into the adaptive access engine’s standard format (e.g., OSCF), ensuring uniformity and compatibility with downstream processing.

Once events are ingested, the context engine streaming service performs multiple functions to enrich and prepare them for further use. The service applies enrichment processes to supplement the event data with additional contextual insights, drawing on metadata caches, historical logs, or cross-referenced data stored within system repositories like the common data lake 408. For events requiring additional policy processing, the service applies Common Criteria Processing (CCP), evaluating each event against predefined policy criteria or thresholds to determine potential risk implications. Once enriched and processed, events are published to a raw events log topic managed by the streaming infrastructure (e.g., Kafka). This publication preserves enriched event details, including key metadata and calculated risk scores, making them accessible to all downstream subscribers.

Subscribers to the raw events log topic, which include policy enforcement systems (e.g., the cloud-based services 402) and other components consuming risk evaluations, receive the enriched events in real time. These subscribers use the risk scores embedded within each event to perform actions based on corresponding access policies. For example, subscribers can decide whether to allow access, block the subject, require step-up authentication, isolate risky activity, or trigger administrative alerts, depending on the detected risk level. By centralizing event enrichment and broadcasting signals to downstream subscribers via a unified topic, the AAE 400 enables scalable, low-latency decision-making for dynamic access control across distributed cloud-based services 402 and third-party services 404.

### §4.2 Logical evaluation of streamed data

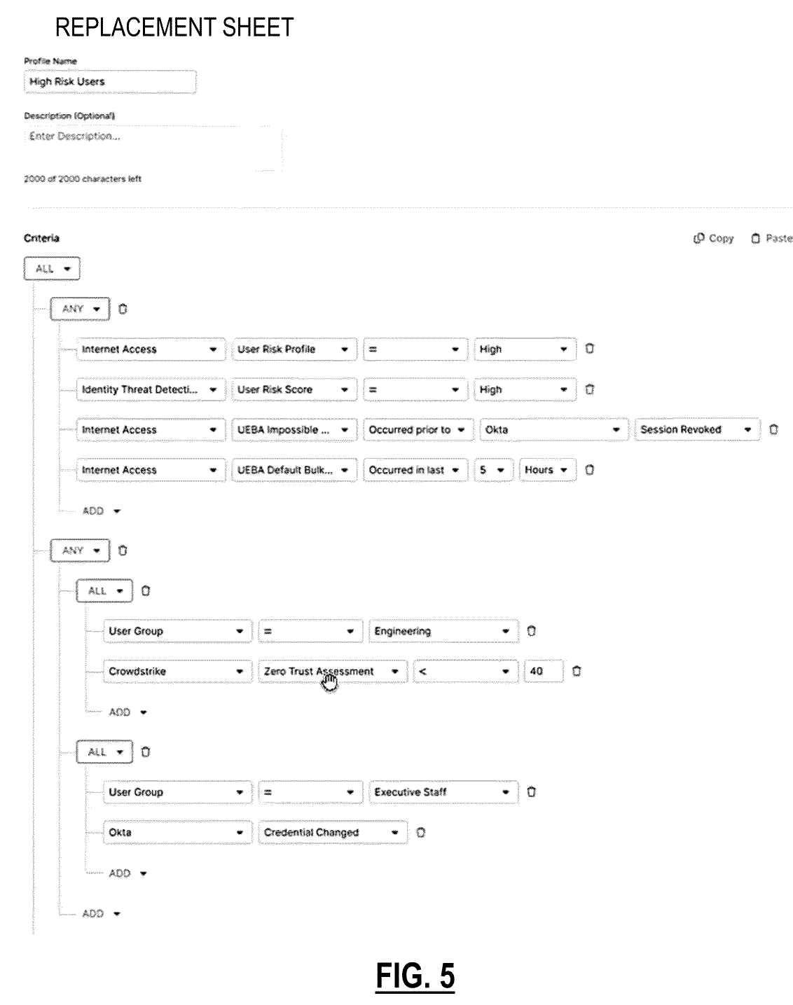

FIG. 5 is a screenshot of an interactive User Interface (UI) for constructing logical expressions. The disclosed system and method includes logical evaluation of streamed data enabling the dynamic application of logical expressions to real-time, continuous streams of data received from multiple sources. The system is designed to process high-volume events by temporarily or persistently storing incoming values and evaluating them against user-defined rules including configurable criteria. Logical expressions are interactively constructed through an intuitive UI, as illustrated in FIG. 5, where administrators can define conditions by using logical operators such as "AND" and "OR", i.e., all and any, to link multiple criteria. Each criterion corresponds to attributes in the incoming event stream, such as risk scores exceeding a threshold, device posture classifications, authentication geolocation anomalies, or session metadata. This modular and configurable approach simplifies management while enabling rapid adaptation to evolving security and operational needs.

The system begins with producers and connectors, which continuously send contextual data streams containing raw observations (e.g., user activity, device attributes, session metadata) to the context streaming service. The producers include both cloud-based services 402 and integrated third-party systems 404, with connectors dynamically transforming external payloads into the standardized OSCF format supported by the engine. Once the streaming service receives these events, it processes them by enriching the event data with supplemental context signals and applying dynamic CCP if required. These criteria correspond to predefined rules stored in system memory that evaluate attributes of the incoming event. For example, an event could be processed and flagged for higher risk if it meets criteria such as "Risk Score > 80 AND Device Posture = Risky AND Authentication Failures > 3." Alternatively, flexible "OR" conditions might flag events based on criteria such as "Risk Score > 80 OR Authentication Geolocation = Suspicious OR Large Volume of Downloads." After evaluation, annotated events are forwarded to a raw events log topic managed by streaming infrastructure (e.g., Kafka), providing enriched contextual insights for downstream subscribers.

Once enriched events are published to the raw events log topic, downstream systems such as context nugget consumers consume these events and retrieve relevant contextual information to apply configured policies. Based on the risk score or other enriched attributes of the event, these systems take dynamic actions such as allowing or blocking access, issuing step-up authentication for additional verification, isolating high-risk activity, or escalating alerts to administrators. Temporary or persistent storage within the context streaming service ensures efficient evaluation, enabling the processing of real-time data without latency while preserving historical context for future analysis.

An important feature of this system is the interactive UI, which enables administrators to define rules and criteria via an intuitive interface. As shown in FIG. 5, the UI provides configurable fields to set thresholds, ranges, or inclusion/exclusion lists for various attributes and allows users to link the criteria with logical operators such as "AND" and "OR." Updates to logical expressions are applied dynamically across the system without requiring downtime or manual intervention, ensuring that the logical evaluation engine can adapt as new security threats or operational requirements arise. Events evaluated by the system can also include administrator overrides to mitigate false positives, as defined by tools such as the context override manager 418. Once processed, enriched events are annotated with metadata, such as updated risk scores, classification flags (e.g., "High Risk"), or contextual overrides, and propagated to subscribers for further action.

The system architecture also supports iterative refinements to logical expressions based on observed results or evolving policies. Administrators can adjust existing expressions via the UI, adding new criteria, modifying thresholds, or combining conditions to address emerging patterns. This flexibility ensures the system remains relevant and effective in dynamic environments. The modular design enables scalability, allowing the system to handle increasing volumes of incoming data streams while maintaining consistency in decision-making and enrichment. By combining real-time data ingestion, configurable logic, and seamless downstream integration, the system provides a unified framework for adaptive, context-aware security and access control.

### §4.3 Joining streamed and static data

The disclosed system facilitates the dynamic integration of streamed data with static data to enable effective and adaptive policy enforcement. While streamed data represents real-time, continuously changing values associated with subjects (e.g., current risk scores, device posture, session activities), static data comprises preconfigured, relatively stable attributes or metadata that are periodically updated (e.g., user group memberships, organizational hierarchies, department information, or device registration status). By systematically joining streamed data with static data, the system creates a unified context that supports comprehensive and real-time policy evaluation. This integration ensures that policy enforcement decisions are informed by both dynamic, time-sensitive factors and static, foundational attributes of users, devices, and other entities.

The system achieves this data integration in several steps. First, streamed data enters the system through producers and connectors and is processed by the context streaming service. Examples of streamed attributes may include a user’s current risk score (e.g., derived from recent activities such as failed authentication attempts or anomalous geolocations), a device’s current posture (e.g., operating system status or compliance levels), or session metadata (e.g., current IP address or application activity). Streamed events are consumed, validated, and enriched by the context streaming service, which applies rule-based logic by evaluating these attributes against preconfigured expressions.

Simultaneously, static data is maintained within the system’s data repositories, such as the common data lake 408, RDS, or Redis cache. Examples of static data include user profile information (e.g., login ID, department, or group membership) and device registration data (e.g., device owner or corporate/non-corporate flag). This repository of static data is periodically synchronized via services such as the context data sync service, which ensures that metadata about users and devices remains accurate and up-to-date. Static data is efficiently cached in Redis, facilitating low-latency access by system components such as the context streaming service and third-party connectors.

During the logical evaluation stage, the system dynamically joins streamed data with static data to create a complete profile for each subject. When a streamed event (e.g., a user’s current device posture and session activity) is processed by the context streaming service, it queries the Redis cache or associated data sync repositories to retrieve relevant static metadata for that user or device. The integration process combines both data types at runtime, enriching the streamed event with complementary static data attributes. For example, when evaluating a current risk score or session activity, the system can incorporate static user group information to enforce policies like the following:

Allow access if the user’s current risk score is below a threshold AND the user belongs to the “low-sensitivity” group.

Block access if the user’s current device posture is classified as risky OR the user belongs to the “high-risk” group.

These joined data sets are critical for enabling nuanced, context-driven policy enforcement that adapts to changing environmental and behavioral conditions while grounding decisions in stable reference data. For example, in cases where static data establishes baseline attributes (e.g., group membership, user role), dynamic conditions like a session’s risk score or anomalous geography can either escalate or modify the enforcement action.

As a practical example, consider a user attempting to access a protected resource. The system retrieves the user’s current risk score (streamed data) and joins it with their static user group data (e.g., whether they are part of the “Executives” group). A policy rule configured in the system might enforce the following logic:

If current risk score > 80 AND the user belongs to the Executives group, initiate step-up authentication.

If the risk score > 90, block access immediately regardless of user group membership.

In this case, without access to joined static data, the system would not be able to differentiate between high-risk users based on their contextual importance, potentially leading to over-permissive or overly restrictive access decisions. The combination of static and streamed data enables the system to balance risk-based evaluation with business-critical considerations, such as user identity and role.

To manage this dynamic integration at scale, the context streaming service applies runtime queries and caching to optimize the computational overhead of joining static and streamed data. The static data is not merged with every streamed event indiscriminately; instead, the system intelligently selects and fetches only the static data attributes explicitly required by the applicable rule expressions or policies being evaluated. This ensures minimal latency in both data retrieval and logical evaluation while maintaining high throughput for streaming event processing.

The enriched, joined data is then evaluated against policies defined in the system’s context engine manager APIs or via the interactive UI (as illustrated in FIG. 5), where administrators can configure logical expressions linking static and dynamic attributes using logical operations ("AND"/"OR"). For instance, an expression might combine a streamed attribute (e.g., current session risk score) with a static property (e.g., department) to enforce fine-grained policies: Allow access if the user is part of the HR department AND their current risk score is below 70.

Upon completing the evaluation, the system annotates the event with enriched metadata derived from both static and streamed data. The enriched event is then published to the raw events log topic for consumption by downstream systems such as context nugget consumers. These policy enforcement systems leverage the enriched events to determine real-time actions such as allowing access, blocking access, issuing step-up authentication, isolating a session, or generating administrative alerts.

This seamless joining of streamed and static data enables the AAE 400 to deliver dynamic, adaptive, and risk-sensitive policy enforcement. It ensures that security decisions are both responsive to real-time context and grounded in reliable, persistent metadata, achieving a balance between flexibility and stability that is critical for modern cloud-based access control systems.

### §4.4 Device and user level enforcement

The disclosed system has the capability to intelligently manage and evaluate a wide range of event contexts, whether related to a user, device, workload, or any combination thereof. By resolving contextual signals down to the granularity of specific entities (e.g., an individual device versus the user associated with that device), the system ensures that policy enforcement actions are precise and relevant to the source of the risk. This targeted approach minimizes unnecessary disruptions while maintaining security integrity, even in scenarios where subjects interact across multiple devices or workloads.

At the core of the system is the ability to dynamically analyze and classify events into distinct context categories, including user-related contexts (e.g., behavioral signals, authentication events, identity modifications), device-based contexts (e.g., posture checks, compliance metrics), and workload-related contexts (e.g., application processes, cloud session activity). Each incoming event is matched against preconfigured logical criteria defined within the system, which specify the type of context involved and the associated enforcement action to be applied. By distinguishing between context types, the system enables precise and adaptive actions that are tightly scoped to the specific risk source identified.

For example, consider a scenario where the satisfied criteria is user-based, such as an unexpected credential change detected in an integrated identity provider like Okta. This event indicates potential identity compromise, requiring immediate action to mitigate risk to the organization. The system dynamically evaluates the context of the event and identifies that it is tied directly to the user rather than a specific device or workload. Based on the configured criteria, the system selects user-wide enforcement actions designed to block all activity originating from the compromised user. Such actions would include revoking session tokens, invalidating authentication cookies, and blocking ongoing traffic from all devices associated with the user’s identity. This ensures comprehensive protection by isolating the user across the entire cloud environment while awaiting further remediation, such as re-verifying their identity or resetting credentials.

Alternatively, if the satisfied criteria is device-based, such as a posture check revealing that a specific device is not in compliance with organizational security standards (e.g., outdated operating system, misconfigured endpoint protection, or unmanaged status), the system adopts a more scoped enforcement strategy. Instead of applying policy actions universally to the user, the system limits enforcement actions to the device in question. The system may block traffic or suspend activities originating specifically from the offending device, while allowing all other compliant devices associated with the same user to retain access to resources. For example, if the user is operating two devices, one compliant laptop and one non-compliant tablet, the system will block activities initiated by the tablet while permitting ongoing sessions and access requests from the laptop. This nuanced enforcement ensures minimal disruption to the user while maintaining security at the device level.

The system achieves this precise targeting by leveraging dynamic event classification and context lineage tracking. Incoming events pass through the context streaming service, where attributes are enriched with relevant metadata, such as whether the context is tied to a specific user (e.g., login ID, group membership) or device (e.g., device ID, posture status). This enriched context is evaluated against the configured logical criteria in real time. Once an event satisfies a criteria, the system uses the associated context metadata to determine the scope of the enforcement action, ensuring that blocks, alerts, or monitoring efforts only affect the appropriate target entity, whether that is a user, device, workload, or combination of these.

Importantly, the system supports the evaluation and enforcement of mixed contexts, where criteria involve multiple types of entities or signals. For example, suppose a configured policy detects risk when there is high-risk user activity on a device with insufficient posture. In this case, enforcement actions may apply jointly to both the user and the device but in a hierarchical or proportional manner. For example:

Traffic originating from the risky device may be blocked entirely (device-level enforcement).

Concurrently, access attempts by the user to sensitive systems may require step-up authentication across all devices (user-level enforcement).

Another example involves workload-specific contexts, wherein criteria focus on processes or applications operating within a cloud session. For instance, if a particular workload exhibits anomalous activity (e.g., high data transfer volume combined with unusual API calls), the system can block or isolate the workload’s session while still allowing ongoing activity for the unaffected workloads being accessed by the same user or device. This workload-specific enforcement ensures that risks native to one application do not propagate across the broader environment.

To achieve such intelligent scoping, the system benefits from modular components including context cache sync, which provides low-latency access to metadata about users, devices, and workloads, and the context nugget distributor 406, which publishes enriched risk signals and contextual metadata for consumption by policy enforcement points (e.g., cloud-based services 402). By dynamically retrieving and evaluating context signals, the system ensures that enforcement actions are scoped based on precise entity-level information without sacrificing real-time efficiency.

The ability to evaluate multiple context types independently or in combination minimizes unnecessary disruptions while providing highly adaptive security responses. User-level actions ensure risks tied to identity compromise are comprehensively addressed across all devices, while device-specific enforcement protects organizational assets without fully blocking a user’s productive activity. Additionally, workload-specific targeting preserves the functionality of unaffected applications while isolating anomalous processes. This intelligent and nuanced enforcement strategy enhances security while maintaining operational flexibility, allowing organizations to respond promptly and accurately to diverse event contexts.

### $4.5 Multi-level nested logical expressions

The disclosed system provides robust support for multi-level nested logical expressions, enabling advanced evaluative capabilities for continuously streamed data from diverse sources. Logical expressions form the backbone of the system’s dynamic data processing and policy enforcement mechanisms, allowing administrators to set up complex rules with multiple layers of conditional logic to identify, evaluate, and act upon contextual signals. These multi-level expressions are particularly essential for scenarios requiring nuanced evaluations based on interrelated criteria across users, devices, workloads, and sessions, where the outcome of one condition may influence the evaluation of others.

A multi-level nested logical expression is a hierarchy of rules where individual conditions ("criteria") are grouped and combined using logical operators such as AND, OR, and NOT, and where groups themselves can be embedded within other groups. This nested structure permits the evaluation of intricate relationships between criteria, ensuring comprehensive analysis of streamed event data. Each logical group operates as a standalone unit until the higher-level expression evaluates its outcome in conjunction with other groups. By allowing flexible nesting, the system ensures administrators can define rules ranging from simple one-dimensional criteria to deeply layered conditional frameworks, all of which process and act upon real-time streamed data.

The system achieves nested logical evaluation through a modular processing architecture. Incoming data streams, such as user risk scores, device posture statuses, and session metadata, are first ingested by the context streaming service, where the event data is validated and enriched with relevant metadata. During enrichment, the system loads configured nested logical expressions stored in memory, dynamically parsing the hierarchy of conditions into discrete groups and subgroups that are evaluated sequentially or recursively. Each incoming event attribute is matched against the criteria within the nested structure, with intermediate results being stored in transient memory or cache for subsequent evaluation.

For example, consider the following logical expression containing nested conditions:

Block access if:

Device posture = Non-compliant AND Session risk score > 75

OR

User credential change detected AND Authentication Failures > 3 OR User belongs to “Sensitive Group” AND Impossible Travel flagged

The system evaluates this expression in a stepwise manner:

First, it assesses the individual conditions contained in each logical subgroup (e.g., "Device posture = Non-compliant" and "Session risk score > 75").

The numeric or Boolean results of these evaluations are grouped together based on their respective operators (e.g., "AND").

Subgroups within the second logical group, such as "User credential change detected AND Authentication Failures > 3", are recursively evaluated, where intermediate outcomes influence the larger "OR" condition.

Finally, the system aggregates outputs from all logical groups to decide whether the overall top-level expression is satisfied (e.g., whether access should be blocked).

The ability to evaluate nested expressions requires the system to dynamically handle dependencies between conditions across varying levels of hierarchy. For example, the outcome of evaluating the condition "Session risk score > 75" may impact the subsequent evaluation of "Device posture = Non-compliant," especially if both are grouped under an AND condition. Intermediate results are cached or stored in memory to ensure efficient processing, particularly for high-velocity data streams where events may involve hundreds or thousands of evaluations per second.

Critical to the system’s nested logical expression functionality is the interactive UI (as depicted in FIG. 5), which allows administrators to construct multi-level expressions with ease. The UI provides drag-and-drop functionality for adding criteria into nested groups, linking them with logical operators, and visualizing their relationships using a tree-like structure. For example, administrators can define rules such as:

Allow access if:

Device posture = Compliant AND

User credential verified] OR [Session risk score ≤ 50 AND No Impossible Travel flagged

The UI dynamically updates the display as expressions are modified, making it easy to create or adjust nested logical rules without requiring programming knowledge. Furthermore, administrators can refine expressions by specifying thresholds for numeric attributes (e.g., “Session risk score > 75”) or toggle inclusion/exclusion lists (e.g., specific user groups, device types, or workloads).

The evaluation process extends seamlessly to multi-source streamed data, where attributes involving users, devices, workloads, and sessions are processed within the context of nested rules. For instance:

When streamed attributes indicate multiple risk factors from different producers (e.g., ZIA or ZPA), nested expressions can evaluate whether the combination of these risk factors exceeds the configured thresholds at different levels of hierarchy.

By grouping attributes into logical subgroups, evaluations remain modular and efficient, as intermediate subgroup results are cached and reused for higher-level processing.

Once the nested expressions are fully evaluated, the system annotates the event with enriched metadata and forwards it to relevant subscribers. Depending on the policy configuration and the logical outcomes, downstream systems such as context nugget consumers (e.g., cloud-based services 402) perform actions such as blocking access, issuing step-up authentication, isolating sessions, or allowing ongoing activity.

Supporting multi-level nested logical expressions empowers the system to handle highly intricate scenarios that reflect real-world complexities in modern cloud security environments. By providing deep configurability and real-time execution, the system ensures scalable, adaptive responses aligned with nuanced security policies. It processes incoming streamed data efficiently while dynamically applying hierarchical conditions for maximally informed policy enforcement decisions.

### §4.6 Dynamic reevaluation

The disclosed system incorporates the ability to dynamically reevaluate and adapt logical criteria at runtime whenever conditional logic or rules governing policy decisions are modified. This capability is critical for maintaining adaptive policy enforcement in dynamic environments, where shifting conditions, emerging risks, or evolving operational requirements necessitate real-time updates to policy frameworks. By seamlessly reevaluating all entities affected by updates to criteria, the system ensures alignment with current rules and conditions while preserving responsiveness, flexibility, and robustness. This adaptive reevaluation process is essential for continuous enforcement in streaming environments where incoming events are processed and acted upon in real time.

The system achieves runtime reevaluation through its modular and event-driven architecture. Logical criteria, defined as individual rules or combinations of rules, are constructed and stored via the system’s context engine manager or configured interactively using the UI (as depicted in FIG. 5). These criteria govern the evaluation of streamed data, such as user risk scores, device postures, and workload activities, and are linked via logical operators (e.g., AND, OR, NOT) to form actionable expressions. Whenever a user modifies a condition via the UI (e.g., adjusting thresholds, adding new criteria, or modifying grouping logic), the system immediately propagates these updates across its processing pipeline. This ensures that all affected components, streaming services, producers, consumers, or downstream subscribers, remain synchronized with the updated rules.

At runtime, the system dynamically reevaluates all previously processed and ongoing streamed events using the new conditional logic. For example, consider a scenario where a policy is updated to lower the acceptable threshold for a risk score condition from “Risk Score ≤ 60” to “Risk Score ≤ 50.” The system identifies the modified condition and initiates a cascading reevaluation of all entities currently subjected to the prior rule or those flagged for further processing. Using its contextual cache and metadata repositories (e.g., Redis cache, common data lake 408) to access previously evaluated and stored event attributes, the system reevaluates each event in light of the updated criteria. This process is efficient and scalable, as only entities impacted by the logic change are reevaluated, rather than requiring full system re-computation.

Dynamic reevaluation also applies to nested logical expressions, cases where conditions at multiple levels are interdependent and require reprocessing to account for updated subgroup evaluation results. For example, consider a nested expression such as:

Block access if:

Device posture = Non-compliant AND Session risk score > 60

OR

User credential change detected AND Risk Score ≤ 70

If the acceptable session risk score threshold is updated to Risk Score > 50, the system reevaluates not only the primary condition (i.e., "Session risk score > 60") but also recomputes the results of all nested subgroups affected by the change. Once updated intermediate results are available, the system recalculates higher-level expressions and applies updated policy actions (e.g., block, allow, or step-up authentication) based on the new logic.

One key element of the system’s adaptive runtime capability is its event-driven processing model, which leverages Kafka topics to broadcast updates across relevant components. When a condition is modified, the system publishes the changes to a dedicated criteria update topic, notifying all dependent services about the new rules.

A key advantage of the system is that changes to conditional logic do not require downtime or manual intervention for propagation. Instead, updates are applied dynamically while the system continues processing incoming streams, ensuring zero disruption to ongoing operations. This ability allows the system to respond seamlessly to real-time environmental shifts, such as detecting anomalous activity or adapting to newly discovered threats. For example:

If security incidents dictate that the system should immediately block users flagged as "medium risk" (instead of monitoring them), administrators can update the risk threshold in real time via the UI. Any incoming or previously processed events meeting the revised threshold are immediately reevaluated, and appropriate actions (e.g., blocking access) are executed without delay.

Similarly, if a new device posture criterion is added to existing policies (e.g., "Device posture = unmanaged"), the system reevaluates all devices against this added condition to apply appropriate enforcement actions such as blocking traffic or isolating the device.

The system’s runtime reevaluation process extends to multi-source contexts, enabling rules that span combinations of entity types, users, devices, workloads, or sessions, to remain synchronized with real-time environmental trends. For example, consider a case where logic updates target specific user-device relationships:

If a device posture classification changes from "compliant" to "non-compliant," the system reevaluates whether any users relying on that device still satisfy the broader criteria.

Conversely, if the device’s posture improves (e.g., patching is completed and posture becomes compliant), the system reevaluates whether prior enforcement actions (e.g., blocking device traffic or prompting step-up authentication) should be reversed.

By performing dynamic adaptive reevaluation, the system ensures it consistently aligns with the latest policies and logical criteria, providing robust and highly flexible policy enforcement in unpredictable or rapidly changing environments. Its ability to immediately propagate updates across all affected entities enables organizations to achieve real-time security responsiveness, avoid inconsistencies in enforcement, and seamlessly adjust their access control strategies to accommodate emerging risks or operational demands.

### §4.7 Event context override

The described system includes a dynamic mechanism for overriding event context or signals, enabling policy enforcement to be either time-bound or permanent. This functionality allows administrators to adapt policies in real time by modifying the value of specific event signals that play a critical role in policy evaluations. By overriding event values, the system alters the behavior of these events, directly impacting policy enforcement outcomes based on situational or organizational needs. This override mechanism ensures that policy frameworks remain flexible, enabling security teams to address immediate requirements or implement long-term adjustments depending on the scenario. The ability to manage overrides dynamically enhances the adaptability and customizability of the system, ensuring its alignment with evolving conditions, priorities, or unforeseen situations.

Each streamed event processed by the system carries specific values (e.g., a risk score, device posture status, or session activity metadata) that influence how policies are enforced. These values, along with their context signals, are evaluated against preconfigured logical expressions and criteria to determine how dynamic actions, such as blocking, allowing, issuing step-up authentication, or isolating an entity, are applied. In scenarios requiring situational flexibility, the context override manager 418 provides a centralized interface where administrators can override these values directly. For example, an administrator may alter a user’s risk score to temporarily lower the perceived risk level, allowing the user to complete a necessary action such as accessing a sensitive application or performing a privileged task that would otherwise be blocked by a restrictive policy.

Overrides can be configured to be temporary, enabling dynamic adjustments for a specified duration, or permanent, enforcing long-term changes in the behavior of specific signals or contexts. Temporary overrides are particularly useful in scenarios requiring short-term exceptions, such as granting access to applications critical for resolving immediate operational issues. For instance, if a user’s current risk score is flagged as “high,” preventing access to an important resource, the system allows the administrator to override the value (e.g., setting the risk score to “low”) for a defined duration, such as one hour. The override is applied dynamically, modifying how the user’s contextual metadata interacts with the system’s policy criteria. Once the duration expires, the override is reversed, and the event signal automatically reverts to its original value, restoring the default behavior of policy enforcement. This ensures that temporary overrides remain bound within strict organizational limits, preventing unintended consequences of permissive adjustments.

Permanent overrides, on the other hand, offer long-lasting changes to signal values or event behavior, often used to accommodate gradual shifts in organizational priorities or persistent policy adjustments. For example, if a particular user is consistently flagged for higher-than-acceptable risk scores due to repeated false positives, administrators can apply a permanent override to recalibrate how the user’s metadata is evaluated within the system. This eliminates the need for repeated manual interventions, simplifying operational workflows while maintaining consistent alignment with broader organizational goals.

The system integrates these overrides directly into the context streaming service, ensuring that overridden values are dynamically incorporated into real-time event processing. When a signal value is overridden, the enrichment process within the streaming service treats the adjusted value as authoritative, seamlessly applying it to new and ongoing evaluations without disrupting the real-time processing of other signals. Overrides are logged within the system’s context nugget distributor 406, so all downstream subscribers receive the updated contextual information. This guarantees that the modified event signal is distributed across the entire system consistently, ensuring coherence in enforcement actions.

Additionally, overrides are tracked using metadata that associates each adjustment with details such as the time of application, duration, administrator identity, and the affected signal or entity. For temporary overrides, the system automatically monitors the expiration time and reverts the signal to its original value, or current actual value, at the designated end of the override period. This automates the process, eliminating the need for manual intervention to deactivate temporary modifications and ensuring policies revert to their natural state seamlessly. Permanent overrides are stored persistently within the system, allowing administrators to review or update them as needed via configurable APIs or the context override manager 418 interface.

Consider an example where a security analyst overrides a user’s risk score to bypass a restrictive policy temporarily. The user is flagged as “high risk” due to failed authentication attempts, but they urgently require access to a sensitive reporting application to complete a critical task. The administrator uses the context override manager 418 to modify their risk score, setting it to “medium risk” for 30 minutes, enabling access to the application while retaining controls that restrict higher-risk actions (e.g., access to other corporate systems or sensitive workloads). Once the 30-minute period concludes, the system automatically reverts the risk score, restoring the user’s original flagged status and applying previously blocked policies.

This dynamic override capability extends to multiple event contexts, whether tied to users, devices, workloads, or any combination thereof. For instance, rather than overriding all activities tied to a user flagged as high risk, the system enables scoping of overrides to specific device-based contexts. If a user operates multiple devices, the system allows overrides specific to one non-compliant device, leaving other compliant devices unaffected. Similarly, overrides targeting workload-based signals (e.g., an anomalous application process) can be scoped to allow only activities tied to the specific workload in question, preserving enforcement actions for unaffected workloads within the same session.

The ability to override event signal values dynamically provides unparalleled flexibility for real-time and adaptive policy management. Temporary overrides address immediate operational needs without compromising system integrity, while permanent overrides enable sustained adjustments to align with long-term organizational goals. By offering administrators fine-grained control over event signals and tying overrides to runtime or persistent conditions, the system ensures that policy enforcement is customizable to anticipated changes, external events, and unforeseen scenarios alike, enhancing its responsiveness and robustness in dynamic security environments.

### §4.8 Providing adaptive access for users of a cloud-based system

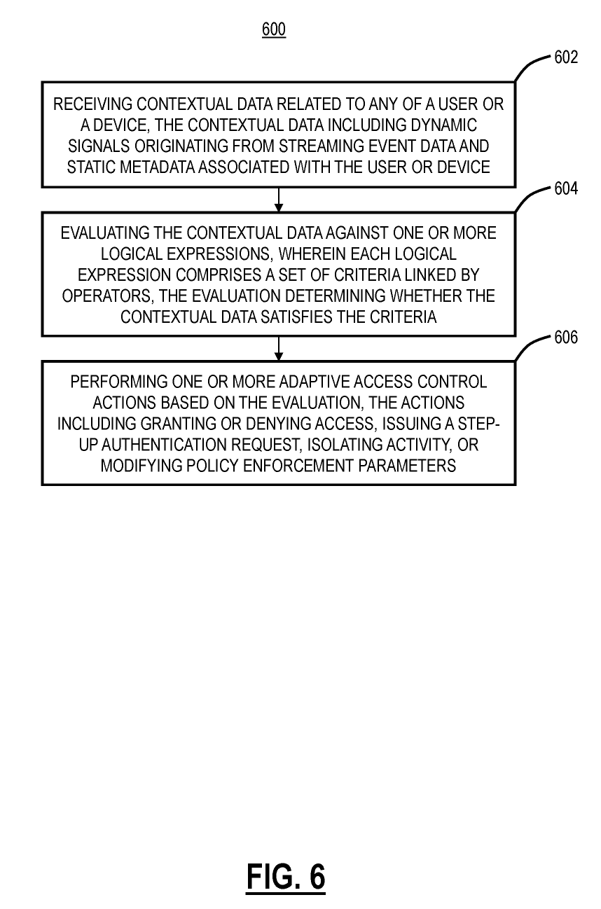

FIG. 6 is a flowchart of a process 600 for providing adaptive access for users of a cloud-based system. The process 600 can be contemplated as a method having steps, a processing device configured to implement the steps, a cloud-based system configured to implement the steps, and as a non-transitory computer-readable medium storing instructions for programming one or more processors to execute the steps. The process 600 includes receiving contextual data related to any of a user or a device, the contextual data including dynamic signals originating from streaming event data and static metadata associated with the user or device (step 602); evaluating the contextual data against one or more logical expressions, wherein each logical expression comprises a set of criteria linked by operators, the evaluation determining whether the contextual data satisfies the criteria (step 604); and performing one or more adaptive access control actions based on the evaluation, the actions including granting or denying access, issuing a step-up authentication request, isolating activity, or modifying policy enforcement parameters (step 606).

The process 600 can further include wherein the contextual data includes a first attribute related to the user's risk score and a second attribute related to the device posture of a device associated with the user. Receiving contextual data can include aggregating data from multiple sources, including cloud-native services and third-party integrations, and enriching the contextual data using cached metadata from prior evaluations. Evaluating the contextual data can include dynamically reevaluating logical expressions at runtime in response to an update to one or more criteria, wherein the updated criteria are propagated without interruption to ongoing policy enforcement. Performing adaptive access control actions can include overriding the behavior of contextual data for a specified duration of time to temporarily adjust policy enforcement parameters. Overriding contextual data can include assigning an adjusted risk score to the user or device, wherein the adjusted risk score is restored to its original or actual value upon expiration of the specified duration. Performing adaptive access control actions can include issuing isolation instructions for a specific device associated with the user while maintaining access for other devices under the user's account. Static metadata can include user group membership, organizational role, device ownership status, or workload classification stored in a relational database, and the metadata is retrieved and combined with dynamic signals during evaluation. Performing adaptive access control actions can include applying real-time updates to access policy enforcement actions based on modifications to criteria thresholds or rules defined by an administrator. Adaptive access control actions can include notifying administrative systems and generating alerts upon the detection of anomalous contextual signals that exceed predefined risk thresholds.

### §4.9 Generating adaptive access policy definitions via logical expressions

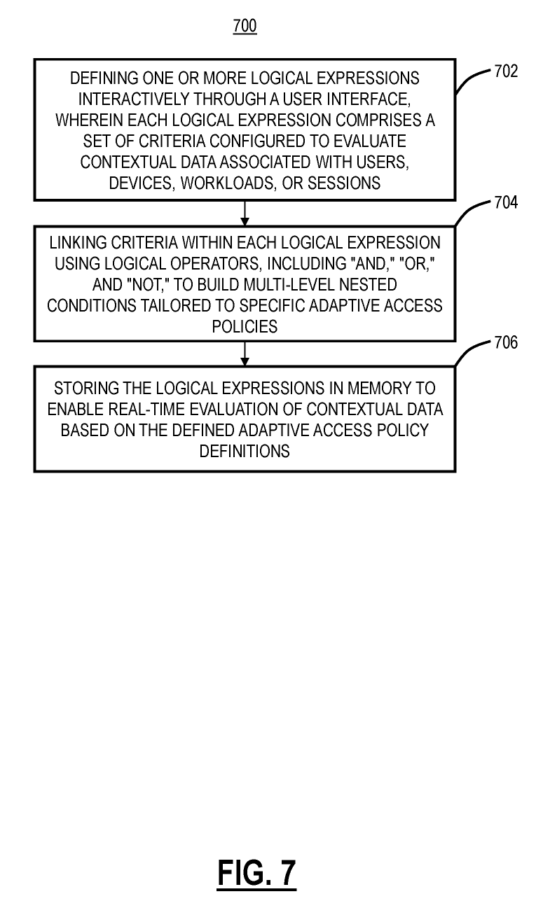

FIG. 7 is a flowchart of a process 700 for generating adaptive access policy definitions via logical expressions for use in adaptive access control of a cloud-based system. The process 700 can be contemplated as a method having steps, a processing device configured to implement the steps, a cloud-based system configured to implement the steps, and as a non-transitory computer-readable medium storing instructions for programming one or more processors to execute the steps. The process 700 includes defining one or more logical expressions interactively through a user interface, wherein each logical expression comprises a set of criteria configured to evaluate contextual data associated with users, devices, workloads, or sessions (step 702); linking criteria within each logical expression using logical operators, including "AND," "OR," and "NOT," to build multi-level nested conditions tailored to specific adaptive access policies (step 704); and storing the logical expressions in memory to enable real-time evaluation of contextual data based on the defined adaptive access policy definitions (step 706).

The process 700 can further include wherein the criteria defined in the logical expressions include any of thresholds for numerical attributes and categorical comparisons. The user interface can provide drag-and-drop functionality to organize criteria into groups and subgroups, select logical operators, and visually represent the structure of nested logical expressions. The criteria configured through the user interface can support combinations of dynamic streamed data signals and static metadata attributes. The steps can include dynamically updating the logical expressions through the user interface, wherein modifications to criteria or operators propagate across the cloud-based system in real-time without interrupting ongoing policy evaluations. Stored logical expressions can be versioned to enable auditing and rollback of policy definitions, maintaining historical tracking of changes to criteria configurations. Defining logical expressions through the user interface can include referencing external contextual signals received from third-party integrations. The stored logical expressions can be distributed to policy enforcement subsystems, enabling uniform and consistent evaluation across distributed enforcement points of the cloud-based system. Defining logical expressions can include specifying adaptive actions associated with their evaluation results, wherein the adaptive actions include any of blocking access, issuing step-up authentication requests, or isolating specific entities. The user interface can support input validation to ensure all configured criteria conform to schema requirements for compatible evaluation.

### §5.0 Processing circuitry and non-transitory computer-readable mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### §6.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for providing adaptive access for users of a cloud-based system, the method comprising steps of:
receiving contextual data related to any of a user or a device, the contextual data including dynamic signals originating from streaming event data and static metadata associated with the user or device;
evaluating the contextual data against one or more logical expressions, wherein each logical expression comprises a set of criteria linked by operators, the evaluation determining whether the contextual data satisfies the criteria; and
performing one or more adaptive access control actions based on the evaluation, the actions including granting or denying access, issuing a step-up authentication request, isolating activity, or modifying policy enforcement parameters.

2. The method of claim 1, wherein the contextual data comprises a first attribute related to a risk score of the user and a second attribute related to a device posture of a device associated with the user.

3. The method of claim 1, wherein receiving contextual data further comprises aggregating data from multiple sources, including cloud-native services and third-party integrations, and enriching the contextual data using cached metadata from prior evaluations.

4. The method of claim 1, wherein evaluating the contextual data further comprises dynamically reevaluating logical expressions at runtime in response to an update to one or more criteria, wherein the updated criteria are propagated without interruption to ongoing policy enforcement.

5. The method of claim 1, wherein performing adaptive access control actions includes overriding behavior of contextual data for a specified duration of time to temporarily adjust policy enforcement parameters.

6. The method of claim 5, wherein overriding contextual data further comprises assigning an adjusted risk score to the user or device, wherein the adjusted risk score is restored to its original or actual value upon expiration of the specified duration.

7. The method of claim 1, wherein performing adaptive access control actions includes issuing isolation instructions for a specific device associated with the user while maintaining access for other devices under an account of the user.

8. The method of claim 1, wherein static metadata further comprises user group membership, organizational role, device ownership status, or workload classification stored in a relational database, and the metadata is retrieved and combined with dynamic signals during evaluation.

9. The method of claim 1, wherein performing adaptive access control actions further includes applying real-time updates to access policy enforcement actions based on modifications to criteria thresholds or rules defined by an administrator.

10. The method of claim 1, wherein adaptive access control actions further include notifying administrative systems and generating alerts upon detection of anomalous contextual signals that exceed predefined risk thresholds.

11. A non-transitory computer-readable medium comprising instructions for providing adaptive access for users of a cloud-based system that, when executed, cause one or more processors to perform steps of:
receiving contextual data related to any of a user or a device, the contextual data including dynamic signals originating from streaming event data and static metadata associated with the user or device;
evaluating the contextual data against one or more logical expressions stored in memory, wherein each logical expression comprises a set of criteria linked by operators, the evaluation determining whether the contextual data satisfies the criteria;
performing one or more adaptive access control actions based on the evaluation, the actions including granting or denying access, issuing a step-up authentication request, isolating activity, or modifying policy enforcement parameters.

12. The non-transitory computer-readable medium of claim 11, wherein the contextual data comprises a first attribute related to a risk score of the user and a second attribute related to a device posture of a device associated with the user.

13. The non-transitory computer-readable medium of claim 11, wherein receiving contextual data further comprises aggregating data from multiple sources, including cloud-native services and third-party integrations, and enriching the contextual data using cached metadata from prior evaluations.

14. The non-transitory computer-readable medium of claim 11, wherein evaluating the contextual data further comprises dynamically reevaluating logical expressions at runtime in response to an update to one or more criteria, wherein the updated criteria are propagated without interruption to ongoing policy enforcement.

15. The non-transitory computer-readable medium of claim 11, wherein performing adaptive access control actions includes overriding behavior of contextual data for a specified duration of time to temporarily adjust policy enforcement parameters.

16. The non-transitory computer-readable medium of claim 15, wherein overriding contextual data further comprises assigning an adjusted risk score to the user or device, wherein the adjusted risk score is restored to its original or actual value upon expiration of the specified duration.

17. The non-transitory computer-readable medium of claim 11, wherein performing adaptive access control actions includes issuing isolation instructions for a specific device associated with the user while maintaining access for other devices under an account of the user.

18. The non-transitory computer-readable medium of claim 11, wherein static metadata further comprises user group membership, organizational role, device ownership status, or workload classification stored in a relational database, and the metadata is retrieved and combined with dynamic signals during evaluation.

19. The non-transitory computer-readable medium of claim 11, wherein performing adaptive access control actions further includes applying real-time updates to access policy enforcement actions based on modifications to criteria thresholds or rules defined by an administrator.

20. The non-transitory computer-readable medium of claim 11, wherein adaptive access control actions further include notifying administrative systems and generating alerts upon detection of anomalous contextual signals that exceed predefined risk thresholds.
